(19) United States
(12) Patent Application Publication
(10) Pub. No.: US 2014/0092249 A1
(43) Pub. Date: Apr. 3, 2014

(54) VEHICLE PERIMETER DETECTION SYSTEM

(71) Applicant: FORD GLOBAL TECHNOLOGIES, LLC, Dearborn, MI (US)

(72) Inventor: Randy Michael Freiburger, Novi, MI (US)

(73) Assignee: FORD GLOBAL TECHNOLOGIES, LLC, Dearborn, MI (US)

(21) Appl. No.: 13/741,950

(22) Filed: Jan. 15, 2013

Related U.S. Application Data
(60) Provisional application No. 61/707,383, filed on Sep. 28, 2012.

(51) Int. Cl. B60Q 11/00; H04N 7/18

(52) U.S. Cl. CPC B60Q 11/00; H04N 7/183
USPC 348/148; 340/435

(57) ABSTRACT

A perimeter detection system for a vehicle has a plurality of sensors provided on an exterior of the vehicle for sensing an object in a peripheral field of view during motion of the vehicle. The plurality of sensors includes a front sensor configured for sensing substantially forward the vehicle, a rear sensor configured for sensing substantially rearward the vehicle; and a side sensor configured for sensing substantially laterally adjacent the vehicle. The perimeter detection system also has a controller for processing the plurality of sensors to detect the object in the peripheral field of view when the vehicle is stopped, such as when a transmission of the vehicle is in park. An output signal is generated that is indicative of the object detected in the peripheral field of view. The output signal may be audible and visual and may include a door lock signal and a window raising signal.

### CROSS-REFERENCE TO RELATED APPLICATION

This application claims priority under 35 U.S.C. §119(e) to, and the benefit of, U.S. Provisional Patent Application No. 61/707,383, entitled “VEHICLE PERIMETER DETECTION SYSTEM,” filed on Sep. 28, 2012, the entire disclosure of which is hereby incorporated by reference.

### FIELD OF THE INVENTION

The present invention generally relates to a controller for a sensor system on an exterior of a vehicle that is configured to operate when the vehicle is stopped or parked, and more particularly to a module that interfaces with the vehicle CAN bus for processing the vehicle sensing components and safety systems when the vehicle is indicated to be stopped by one or a combination of a vehicle steering wheel switch and a vehicle speed or transmission indicator to provide an output signal to the interior cabin of the vehicle.

### BACKGROUND OF THE INVENTION

In the automotive industry it is common practice to supply vehicles for use by commercial businesses, emergency response agencies, and/or law enforcement agencies by modifying vehicles that are produced for more general commercial and non-commercial use. An example of a modification for such specialty users often include adding components to the vehicles, such as lights, sirens, and radios. However, vehicles produced for the general public are more commonly equipped with advanced sensor component systems, such as Reverse Park Assist (RPA), Blind Spot Information System (BLIS), forward crash avoidance sensors, and adaptive cruise control sensors, which are configured for use when the vehicle is in motion.

### SUMMARY OF THE INVENTION

According to one aspect of the present invention, a perimeter detection system for a vehicle includes a plurality of sensors coupled with an exterior of the vehicle for monitoring a peripheral field and generating input signals. A detector is indicative of a parked state of the vehicle. A controller on the vehicle processes the input signals from the plurality of sensors to detect an object in the peripheral field and generates an output signal when the object is detected and the vehicle is in the parked stated. A device is actuated based upon the output signal.

According to another aspect of the present invention, a vehicle perimeter detection system includes a plurality of exterior vehicle sensors for monitoring a peripheral field of a vehicle. A detector is indicative of the vehicle being stopped. A controller processes the sensors to detect an object in the peripheral field when the vehicle is stopped and generates an output signal indicative of the detected object. A device is actuated based upon the output signal.

According to yet another aspect of the present invention, a perimeter detection system for a vehicle has a plurality of sensors provided on an exterior of the vehicle for sensing an object in a peripheral field of view during motion of the vehicle. The plurality of sensors includes a front sensor configured for sensing substantially forward the vehicle, a rear sensor configured for sensing substantially rearward the vehicle; and a side sensor configured for sensing substantially laterally adjacent the vehicle. The perimeter detection system also has a controller for processing the plurality of sensors to detect the object in the peripheral field of view when the vehicle is stopped. An output signal is generated that is indicative of the object detected in the peripheral field of view.

According to another aspect of the present invention, a perimeter detection system for a vehicle includes a plurality of sensors for sensing an object in a peripheral field of view during motion of the vehicle and a controller for processing the plurality of sensors to detect the object in the peripheral field of view when the vehicle is stopped. An output signal is generated that is indicative of the object detected in the peripheral field of view, having an audible signal, a display signal, a door lock signal, and a window raising signal.

According to yet another aspect of the present invention, a perimeter detection system for a vehicle includes a plurality of sensors for sensing an object in a peripheral field of view during motion of the vehicle and a controller for processing the plurality of sensors to detect the object in the peripheral field of view when the vehicle is stopped. An output signal is generated that is indicative of a position of the object detected in the peripheral field of view relative to the vehicle, such as to the rear of the vehicle, to the front of the vehicle, to the driver side of the vehicle, and to the passenger side of the vehicle.

According to yet another aspect of the present invention, a perimeter detection system for a vehicle includes a plurality of sensors for sensing an object in a peripheral field of view during motion of the vehicle and a controller for processing the plurality of sensors to detect the object in the peripheral field of view when the vehicle is stopped and a manual switch located on a steering wheel of the vehicle is actuated.

According to yet another aspect of the present invention, a perimeter detection system for a vehicle includes a plurality of sensors for sensing an object in a peripheral field of view during motion of the vehicle and a controller for processing the plurality of sensors to detect the object in the peripheral field of view when a transmission of the vehicle is in park.

According to yet another aspect of the present invention, a perimeter detection system for a vehicle includes a plurality of sensors for sensing an object in a peripheral field of view during motion of the vehicle and a controller for processing the plurality of sensors to detect the object in the peripheral field of view when the vehicle is stopped. An output signal is generated that is indicative of the object detected in the peripheral field of view. The plurality of sensors includes a rear sensor that has a back-up camera, a front sensor that has a front bumper radar sensor, and a side sensor that has a blind spot sensor.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a plan view of a vehicle illustrating an interior of the vehicle and a perimeter detection system on a vehicle, according to one embodiment;

FIG. 2 is a top perspective view of the interior of the vehicle showing a steering wheel including a switch to operate the perimeter detection system, according to one embodiment;

FIG. 3 is a plan view of a vehicle illustrating an overlay of a schematic design of components of the perimeter detection system, according to one embodiment;

FIG. 4 is a block diagram further illustrating the perimeter detection module and inputs and outputs thereof, according to one embodiment; and

FIG. 5 is a flow diagram illustrating a perimeter detection routine shown in FIG. 4, according to one embodiment.

### DETAILED DESCRIPTION OF THE EMBODIMENTS

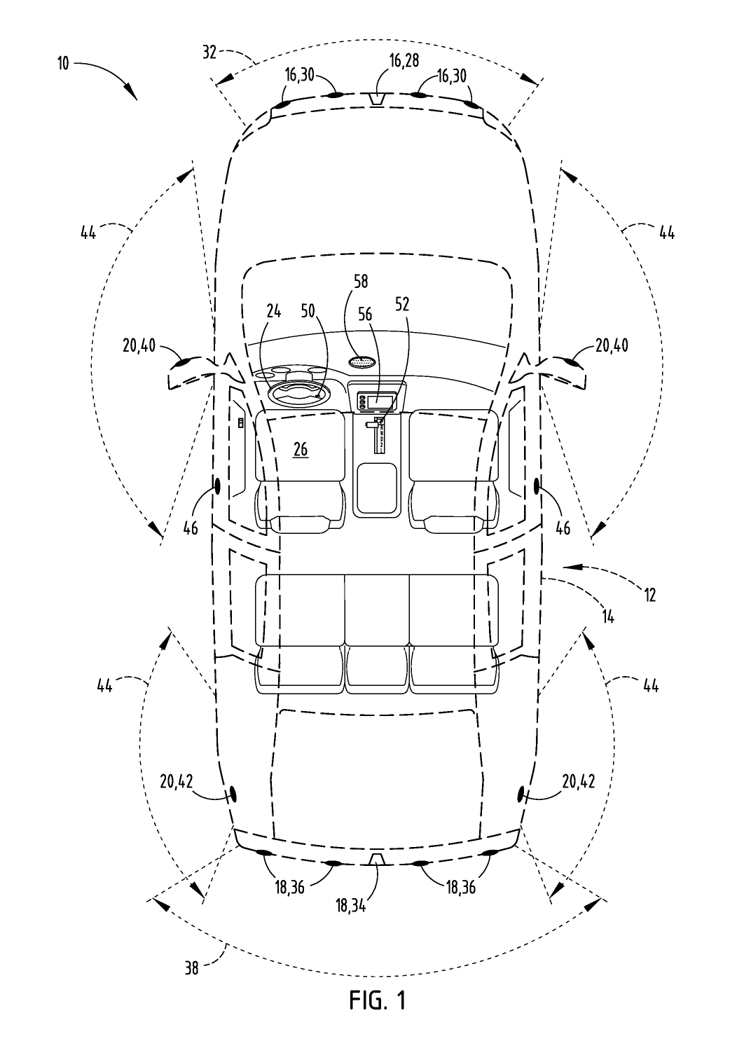

For purposes of description herein, the terms “upper,” “lower,” “right,” “left,” “rear,” “front,” “vertical,” “horizontal,” and derivatives thereof shall relate to the vehicle and its collision detection system as oriented in FIG. 1. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Referring to FIGS. 1-5, reference numeral 10 generally refers to a perimeter detection system for a vehicle 12. The perimeter detection system 10 has a plurality of sensors provided on an exterior 14 of the vehicle 12 for sensing an object in a peripheral field of view during motion of the vehicle 12. The plurality of sensors includes a front sensor 16 configured for sensing substantially forward the vehicle 12, a rear sensor 18 configured for sensing substantially rearward the vehicle 12; and a side sensor 20 configured for sensing substantially laterally adjacent the vehicle 12. The perimeter detection system 10 also has a controller 22 for processing the plurality of sensors to detect the object in the peripheral field of view when the vehicle 12 is stopped. An output signal is generated that is indicative of the object detected in the peripheral field of view.

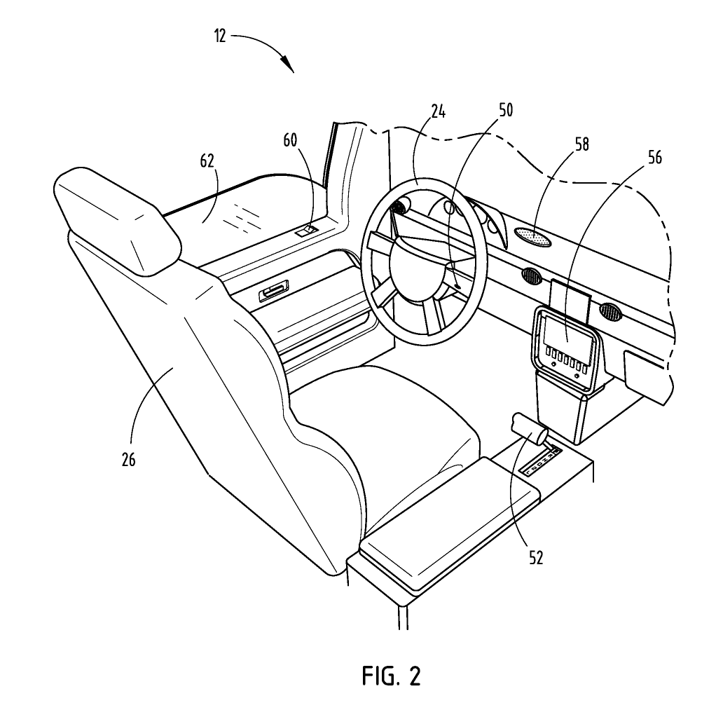

An automotive vehicle 12, as shown in FIGS. 1-2, is generally illustrated as a passenger car having four passenger doors and a steering wheel 24 conventionally arranged forward of the driver's seat 26 in the interior cabin of the vehicle 12. The vehicle 12 may also include a van, truck, or other vehicle that employs a steering wheel. In the illustrated embodiment, the vehicle 12 is configured as an emergency response vehicle such as the type that may be employed by law enforcement agencies, including police, and medical response and rescue personnel, including an ambulance, and other vehicles. The vehicle 12 may be referred to as a specialty vehicle that may include emergency response vehicles and commercial vehicles.

According to one embodiment, as shown in FIG. 1, the vehicle 12 is equipped with a plurality of sensors on the exterior 14 of the vehicle 12. However, it is contemplated that the plurality of sensors may also be located on an interior of the vehicle 12 to monitor the peripheral field of view. The front sensor 16 of the plurality of sensors is shown to include a front camera 28 and a front set of radar sensors 30. The front sensors 16 are also shown to generally include a front field of view 32 directed substantially forward the vehicle 12, such that the front sensors 16 are configured to monitor the front field of view 32 for objects. The front sensors 16 are typically used for adaptive cruise control systems that when actuated generally operate to reduce the speed of the vehicle 12 from a set speed when the vehicle 12 is in motion and the vehicle 12 approaches a relatively slower object in the front field of view 32 or to increase the speed of the vehicle 12 to the set speed when the slower object is not present in the front field of view 32. In addition, the front sensors 16 are commonly used for collision avoidance systems that operate to signal the driver and, in some instances, adjust the speed or alter the path of the vehicle 12 in response to an object in the front field of view 32. Accordingly, the front sensors 16 are typically processed when the vehicle 12 is in motion.

Similarly, the rear sensor 18 of the plurality of sensors, as shown in FIG. 1, includes a rear camera 34 and a rear set of radar sensors 36 that are configured to monitor a rear field of view 38 substantially rearward the vehicle 12 for objects. The rear sensors 18 are typically used for Reverse Park Assist (RPA) that when actuated operates to adjust the rearward speed and direction of the vehicle 12 to guide the vehicle 12 into a parking spot identified in the rear field of view 38. In addition, the rear sensors 18 are commonly used for crash avoidance systems that operate to signal the driver and, in some instances, apply the brake system of the vehicle 12 when an object is detected in the rear field of view 38. Again, the rear sensors 18 are typically processed when the vehicle 12 is in motion.

Moreover, as illustrated in FIG. 1, the side sensor 20 of the plurality of sensors includes a forward set of radar sensors 40 and a rearward set of radar sensors 42 of opposing sides of the vehicle 12 that are configured to monitor a side field of view 44 laterally adjacent the vehicle 12 for objects. The side sensors are commonly used for Blind Spot Information Systems (BLIS) that generally operate to signal the driver when an object is detected in the side field of view 44 and the vehicle 12 begins to move toward the laterally adjacent object, such as in a lane change maneuver. As such, the side sensors are processed when the vehicle 12 is in motion.

It is conceivable that additional sensors 46, including cameras and radar sensors, may be added to the plurality of sensors on the same or alternative locations of the vehicle 12 to increase the peripheral field of view or more accurately detect objects in specific areas of the peripheral field of view. For instance, as shown in FIG. 1, it is understood that aftermarket sensors 46 may be installed on the vehicle 12, such as door security sensors for monitoring objects proximate the front window openings or monitoring any physical contact with exterior body panels of the vehicle 12. As such, the peripheral field of view includes the front, rear, and side fields of view 32, 38, 44 and any additional areas added by existing or additional sensors 46.

As shown in FIG. 2, the steering wheel 24 in the vehicle 12 is part of the steering assembly that is actuatable by the driver to steer the direction of the vehicle 12. In the illustrated embodiment, a switch assembly 50 is located on the steering wheel 24, positioned to be actuated by the driver of the vehicle 12. However, it is conceivable that the switch assembly 50 may be positioned at alternative locations in the interior of the vehicle 12 to be actuated by the driver, such as the instrument panel, center counsel, and floor. As illustrated, a center counsel is positioned between the driver's seat 26 and the passenger's seat that has a transmission or gear shifter 52 that is configured to be actuated by the driver to selectively place a transmission of the vehicle 12 in park, reverse, driver, and other gears, as understood in the art. It is conceivable that the shifter 52 may be alternatively located on the steering wheel column or other conceivable locations, such as the instrument panel. And further, it is contemplated that the shifter 52 may be a button arrangement located on the instrument panel, steering wheel 24, or other conceivable locations.

The perimeter detection system 10, as disclosed herein, is configured to be actuated when the vehicle 12 is stopped or in a parked state, which is indicated by a detector. In one embodiment, as shown in FIGS. 1-2, the detector of the perimeter detection system 10 determines that the vehicle 12 is stopped or in the parked state when the shifter 52 is moved to the park position, thereby putting the transmission in park. In another embodiment, the detector of the perimeter detection system 10 is indicative of the vehicle 12 being stopped or in the parked state when a manual switch of the switch assembly 50 is actuated and/or the shifter 52 is moved to place the transmission in park. The detector may additionally or alternatively include a speed sensor or another capable sensor to determine when the vehicle 12 is stopped to actuate the perimeter detection system 10. It is also contemplated that the perimeter detection system 10 may be actuated by the switch assembly 50 independent of any other determination as to whether the vehicle 12 is stopped.

Upon actuation of the perimeter detection system 10, a perimeter detection module 54 processes the plurality of sensors, including the front sensor 16, rear sensor 18, and side sensors 20, to monitor the peripheral field of view for objects. The peripheral field of view, as shown in FIG. 1, includes the front, rear, and side fields of view 32, 38, 44. Upon detection of an object in the peripheral field of view, the output signal is generated by the perimeter detection system 10. The output signal may include various indicators to the driver of the vehicle 12 and other safety measures, as described in more detail below.

The interior of the vehicle 12, as further illustrated in FIG. 2, includes a display 56 on the instrument panel, which conceivably could also be located on the rear view mirror, proximate the gauge display above the steering wheel column, or other conceivable locations. The output signal generated by the perimeter detection system 10 may actuate the display 56 with a display signal, such as an alert symbol, a textual message, or a video display of the front camera 28, rear camera 34, or other visual transmission from a sensor of the plurality of sensors. For instance, the rear camera 34 may transmit a video feed to the display 56 that shows the rear field of view 38 when an object is detected in the rear field of view 38, such as a person approaching the vehicle 12. Further, the output signal generated by perimeter detection system 10 may actuate an audible signal to a speaker 58. The speaker 58, as shown in FIG. 2, is positioned on the dash of the vehicle 12 and may conceivably be positioned at other locations within the interior of the vehicle 12 or other desired locations to generate the audible signal to be heard by the driver. The speaker 58 can be used to generate the audible signal from the perimeter detection system 10 among other audio signals.

The interior of the vehicle 12, as shown in FIG. 2, includes a driver side door having a door lock mechanism 60 and a power window actuator 62 that may be actuated by the output signal to perform a safety measure. Accordingly, in one embodiment, the output signal actuates the door lock mechanism 60 to prevent the door from being opened from at least the exterior 14 of the vehicle 12. Further, according to another embodiment, the output signal actuates the power window actuator 62, such as an electric window motor, to raise the door window to a closed position. It is conceivable that all the actuatable windows and all the lockable doors of the vehicle 12 may be closed and/or locked by the output signal as a safety measure. It is also conceivable that other safety measures may be performed by the output signal.

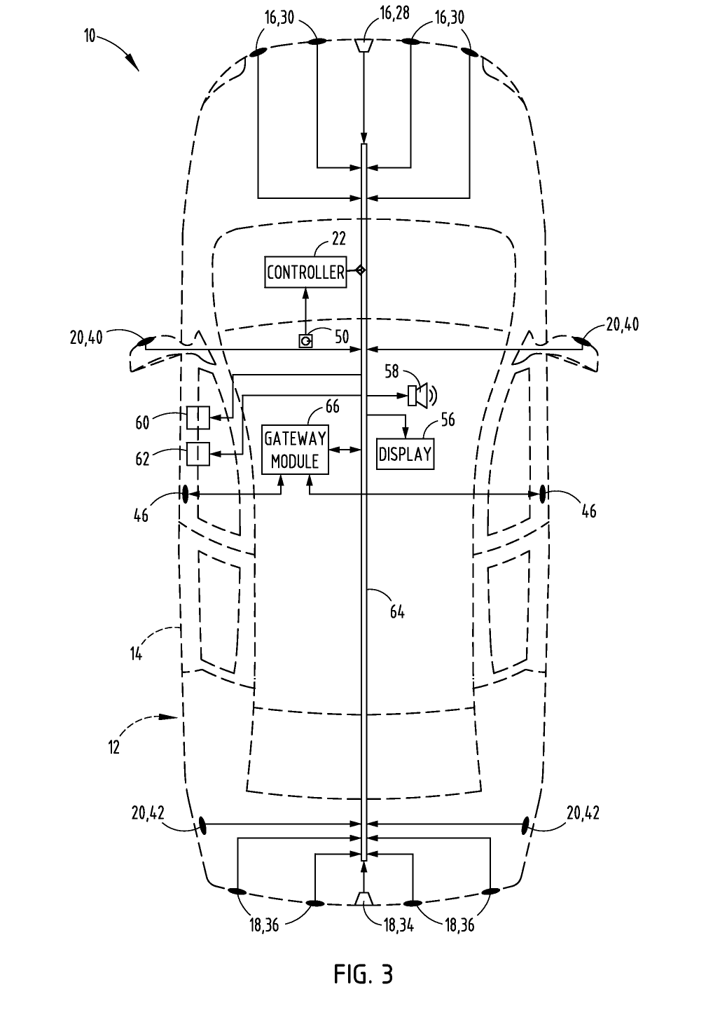

Referring now to FIG. 3, the components of the perimeter detection system 10 are shown schematically within the vehicle 12. Specifically, a CAN bus 64 is shown having an electrical connection to the plurality of sensors and the various outputs devices, including the display 56, the speaker 58, the power window actuators 62, and the door lock mechanisms 60. The CAN bus 64 serves as a data communication bus for transmitting and sharing data. A gateway module 66 is also electrically connected to the CAN bus 64. The gateway module 66 is configured to receive additional sensors 46, such as aftermarket sensors or upfitter provided components, and configure the additional sensors 46 with the perimeter detection system 10. The controller 22 is also electrically connected to the CAN bus 64 to communicate with the plurality of sensors, the gateway module 66, and the various output devices. The switch assembly 50 is electrically connected to the controller 22; however, it is conceivable that the switch assembly 50 may be alternatively connected to the CAN bus 64 to communicate with the controller 22. It should be appreciated that other communication busses or data communications paths including wired and wireless communications may be employed.

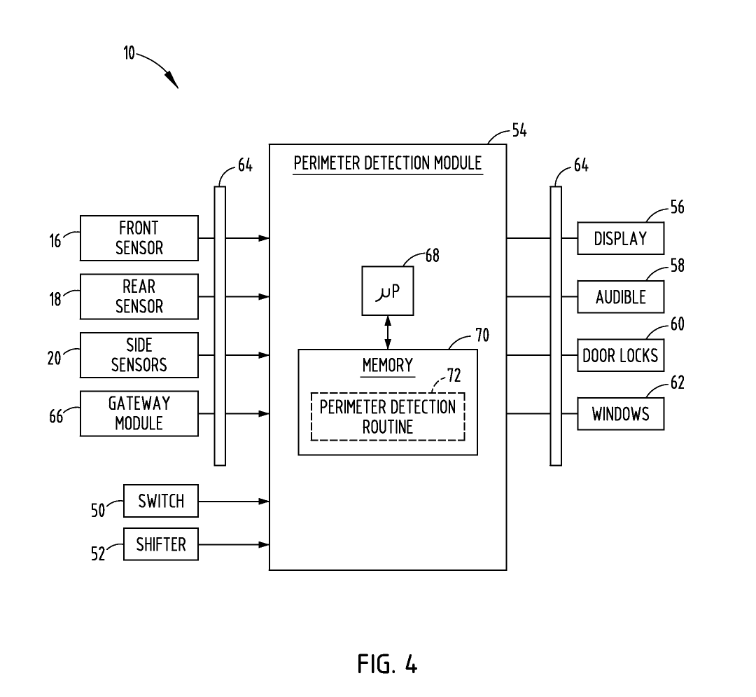

As illustrated in FIG. 4, the controller 22 includes the perimeter detection module 54, which is shown to include control circuitry such as a microprocessor 68 and a memory unit 70, according to one embodiment. The perimeter detection module 54 may be configured as part of a shared controller used for other purposes or configured with multiple microprocessors and memory units integrated in various locations and components of the vehicle 12. The memory may include random access memory (RAM), read-only memory (ROM), and electrically erasable programmable read-only memory (EEPROM). The memory 70 contains a perimeter detection routine 72, which may also be integrated in various memory units in various locations and components of the vehicle 12. The microprocessor 68 executes a perimeter detection routine 72 stored in memory to provide perimeter detection and control.

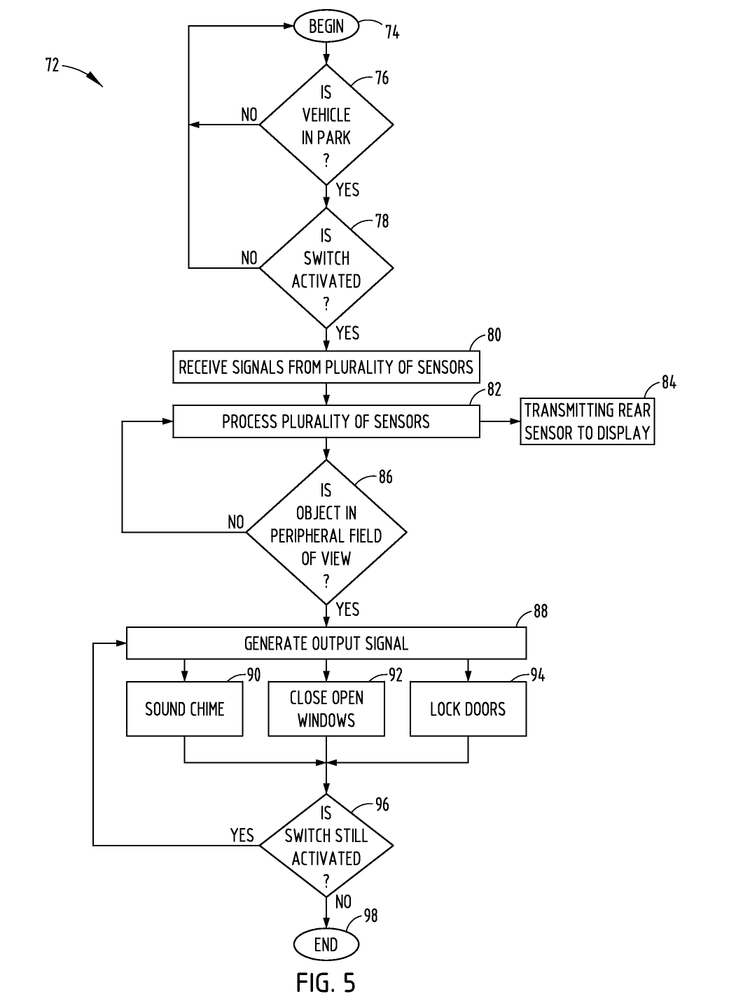

As shown in FIG. 5, one embodiment of the perimeter detection routine 72 is illustrated in a logic flow chart. The routine begins at step 74 and proceeds to step 76 to determine if the vehicle 12 is park. In one embodiment, this determination is based on whether the shifter 52 is aligned with the letter P, indicated as Park, on the center counsel. In another embodiment, the vehicle 12 is determined to be in park when a speed sensor determines that the vehicle 12 is stopped or not in motion relative to the surround environment or the surface supporting the vehicle 12. In yet another embodiment, the vehicle 12 is in park when the transmission of the vehicle is in park. It is conceived that other indications of the parked state of the vehicle 12 may be used to make this determination.

When the vehicle 12 is determined to be in park, the routine proceeds to step 78 to determine whether the switch assembly 50 is actuated. In the illustrated embodiments, the switch assembly 50 includes a manual toggle switch that is moved to the actuated or on position to actuate the switch assembly 50. In another embodiment, the switch assembly 50 may include any conceivable button arrangement configured to manually actuate the switch assembly 50. It is conceivable that the step 78 of determining whether the switch assembly 50 is actuated may be done before or simultaneously with step 76 of determining whether the vehicle 12 is in park. In one embodiment, as illustrated in FIG. 5, when the routine 72 determines that the vehicle 12 is in park and the switch assembly 50 is actuated the routine proceeds to step 80 to receive data and signals from the plurality of sensors.

Upon receiving the data and signals from the plurality of sensors, the routine then proceeds to step 82 to process the data and signals from the plurality of sensors. It is conceivable that the microprocessor 68, illustrated in FIG. 4, would execute this step. When the sensors are being processed, the video from front and rear cameras 28, 34 may be transmitted to the display 56 at step 84 of the routine. It is conceivable that the front camera 28, the rear camera 34, any additional cameras, or a combination of cameras or other sensors may be shown on the display 56. This allows the driver to visually monitor the front field of view 32, rear field of view 38, or other portions of the peripheral field of view.

The perimeter detection routine then proceeds to step 86 to determine whether an object is in the peripheral field of view. The sensors may be configured to monitor the peripheral field of view in several ways. In one embodiment, an object will be detected simply when generally any detectable object enters the peripheral field of view of the sensors. In another embodiment the system may be configured as to only determine that an object is in the field of view when the object is within a set distance from the exterior 14 of the vehicle 12, such as within 3 feet from the vehicle. Another embodiment will only determine that an object is in the field of view when the object is determined to be traveling toward the exterior 14 of the vehicle 12, not merely passing through the peripheral field of view or moving away from the peripheral field of view. It is understood that other conceivable configurations of the sensors could be customized for determining whether an object is considered with the peripheral field of view, including separate configurations for different areas of the peripheral field of view.

At step 86, it is also contemplated that a user, such as the driver, may sense an object in the peripheral field of view from monitoring the display 54 or monitoring the peripheral field of view. The user, upon sensing the object may manual input the determination that an object is in the peripheral field of view by actuating a button or other component of the switch assembly 50. Accordingly, the driver may decide to actuate the button or other component of the switch assembly 50 to manually input the determination that an object is in the peripheral field of view before the processed data from the sensors makes such a determination.

At step 88, the routine 72 proceeds to generate an output signal. Again, this output signal may be highly customizable and configurable. In the illustrated embodiment, the output signal sounds a chime using the speaker 58 at step 90, closes any open actuatable windows at step 92, and locks the vehicle doors at step 94. As explained above, the output signal may include safety measures, alert signals, and a combination thereof. It is conceivable that the routine may be configured to include any conceivable alert signal and safety measure that the vehicle or aftermarket additions may execute, including turning on police lights. Once the output signal has been generated the driver will be able to deactivate any alert signal and safety measures actuated by the output signal at step 96 of the routine by deactivating the switch assembly 50. Deactivating the switch assembly 50 will end the routine 72 at step 98.

It should be appreciated that one or more sensors or output devices may be provided by an upfitter or end user of the vehicle 12 to perform specified function when the vehicle 12 is stopped and the perimeter detection system 10 is actuated. Also it should be understood that the user is able to define the inputs and outputs to be used by the perimeter detection module and its logic to provide a user defined action or output. The user will also define and provide an input, such as a radio switch or key fob switch, to enable and disable a “surveillance mode” of operation employing the perimeter detection routine module.

These sensors systems that may also be alternatively configured and processed for address systems, radar providing vehicle signals such as vehicle speed as a hardwired output or CAN bus message to upfitters that need that information to ensure that a condition has been met prior to activating an action to occur. An example would be to know that vehicle speed is zero, vehicle not moving, to initiate a lift assist for passengers that may require access while using a wheel chair.

It will be understood by one having ordinary skill in the art that construction of the described invention and other components is not limited to any specific material. Other exemplary embodiments of the invention disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

It is also important to note that the construction and arrangement of the elements of the invention as shown in the exemplary embodiments is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the interfaces may be reversed or otherwise varied, the length or width of the structures and/or members or connector or other elements of the system may be varied, the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present invention. The exemplary structures and processes disclosed herein are for illustrative purposes and are not to be construed as limiting.

It is also to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A perimeter detection system for a vehicle comprising:
a plurality of sensors coupled with an exterior of the vehicle for monitoring a peripheral field and generating input signals;
a detector indicative of a parked state of the vehicle;
a controller on the vehicle for processing the input signals from the plurality of sensors to detect an object in the peripheral field and generating an output signal when the object is detected and the vehicle is in the parked stated; and
a device that is actuated based upon the output signal.

2. The perimeter detection system of claim 1, wherein the detector includes a switch coupled with an interior of the vehicle, and wherein the switch is actuated for the controller to process the plurality of sensors.

3. The perimeter detection system of claim 1, wherein the parked state is includes at least one of the vehicle being stopped, a transmission of the vehicle being in park, and a switch within the vehicle being actuated.

4. The perimeter detection system of claim 1, wherein the plurality of sensors includes:
a front sensor configured for sensing substantially forward the vehicle;
a rear sensor configured for sensing substantially rearward the vehicle; and
a side sensor configured for sensing substantially laterally adjacent the vehicle.

5. The perimeter detection system of claim 4, wherein the rear sensor includes a back-up camera and the output signal includes a display signal.

6. The perimeter detection system of claim 4, wherein the rear sensor includes a rear bumper sensor, the front sensor includes a front bumper sensor, and the side sensor includes a blind spot sensor, and wherein the output signal includes an audible signal and a display signal.

7. The perimeter detection system of claim 1, wherein the device includes a door lock mechanism coupled with a vehicle door and the output signal includes a door locking signal to move the door lock mechanism to a locked position.

8. The perimeter detection system of claim 1, wherein the device includes a power window actuator coupled with a door window on the vehicle and the output signal includes a window raising signal for raising the door window.

9. The perimeter detection system of claim 1, wherein the output signal includes position signal that has at least one of an audible signal and a display signal, and wherein the position signal is indicative of a position of the object relative to the vehicle.

10. The perimeter detection system of claim 1, further comprising:
a manual switch located on a steering wheel of the vehicle, wherein the switch is actuated for the controller to process the plurality of sensors.

11. A vehicle perimeter detection system comprising:
a plurality of exterior vehicle sensors for monitoring a peripheral field of a vehicle;
a detector indicative of the vehicle being stopped;
a controller for processing the sensors to detect an object in the peripheral field when the vehicle is stopped and generating an output signal indicative of the detected object; and
a device that is actuated based upon the output signal.

12. The perimeter detection system of claim 11, wherein the detector includes at least one of a vehicle transmission having a park position indicative of the vehicle being stopped and a switch coupled with an interior of the vehicle that is actuatable to indicate the vehicle being stopped.

13. The perimeter detection system of claim 11, wherein the output signal generates a command, and wherein the command includes at least one of an audible signal, a display signal, a door lock signal, and a window raising signal.

14. The perimeter detection system of claim 11, wherein the plurality of sensors includes:
a front sensor configured for sensing substantially forward the vehicle;
a rear sensor configured for sensing substantially rearward the vehicle; and
a side sensor configured for sensing substantially laterally adjacent the vehicle.

15. The perimeter detection system of claim 14, wherein the rear sensor includes a back-up camera and the output signal includes a display signal.

16. The perimeter detection system of claim 14, wherein the rear sensor includes a rear bumper sensor, the front sensor includes a front bumper sensor, and the side sensor includes a blind spot sensor, and wherein the output signal includes an audible signal and a display signal.

17. The perimeter detection system of claim 11, further comprising:
a switch located on a steering wheel of the vehicle, wherein the controller generates the output signal when object is detected in the peripheral field, the vehicle is stopped, and the switch is actuated.

18. A perimeter detection system for a vehicle comprising:
a plurality of sensors provided on an exterior of the vehicle for sensing an object in a peripheral field of view during motion of the vehicle, wherein the plurality of sensors includes:
a front sensor configured for sensing substantially forward the vehicle;
a rear sensor configured for sensing substantially rearward the vehicle; and
a side sensor configured for sensing substantially laterally adjacent the vehicle;
a controller for processing the plurality of sensors to detect the object in the peripheral field of view when the vehicle is stopped; and
an output signal indicative of the object detected in the peripheral field of view.

19. The perimeter detection system of claim 18, wherein the output signal includes an audible signal and a display signal.

20. The perimeter detection system of claim 18, wherein the output signal includes a door lock signal and a window raising signal.
